(19) United States
(12) Patent Application Publication
(10) Pub. No.: US 2025/0255294 A1
(43) Pub. Date: Aug. 14, 2025

(54) APPARATUS FOR PERFORMING EX-VIVO PERFUSION OF AN ORGAN, AND CORRESPONDING METHOD

(71) Applicant: Oxford University Innovation Limited, Oxford (GB)

(72) Inventor: Richard DUMBILL, Oxford (Oxfordshire) (GB)

(21) Appl. No.: 18/856,756

(22) PCT Filed: Apr. 17, 2023
(86) PCT No.: PCT/GB2023/051015

§ 371 Date: Oct. 14, 2024

(30) Foreign Application Priority Data
Apr. 19, 2022 (GB) 2205692.3

(51) Int. Cl. A01N 1/143; A01N 1/144

(52) U.S. Cl. CPC A01N 1/143; A01N 1/144

(57) ABSTRACT

Apparatus and methods for performing ex-vivo perfusion of an organ are disclosed. In one arrangement, an organ receiving unit (4) receives an ex-vivo organ and provides fluidic connections to a vasculature of the received organ. A first conduit system defines a perfusate flow circuit (21) including a flow path through the vasculature of the received organ. A perfusate pumping system (14) drives a circulatory flow of perfusate in the perfusate flow circuit and through the vasculature of the received organ. A second conduit system defines a dialysate flow circuit (22). A dialysate pumping system drives a circulatory flow of a dialysate in the dialysate flow circuit. A dialysis unit processes the perfusate using the dialysate, the dialysis unit comprising a membrane configured to contact the perfusate in the perfusate flow circuit on one side of the membrane and the dialysate in the dialysate flow circuit on the other side of the membrane. The membrane allows material to pass between the perfusate flow circuit and the dialysate flow circuit as a transmembrane flux.

The present disclosure relates to ex-vivo perfusion of organs.

Ex-vivo perfusion systems are used in the context of organ transplantation to preserve organs between retrieval from deceased donors and transplants into recipients. Typical systems can safely preserve an organ for only a limited time, typically up to a maximum of 24 hours. Longer safe preservation times would be desirable to facilitate organ transplant logistics and/or to allow organs to be manipulated prior to transplant, for example to engineer them to be more suitable for the intended recipient.

A reason for the limited preservation time is that the biochemical environment of organs deteriorates with time during the ex-vivo perfusion. This is due to the accumulation of metabolic waste produced by the organ, and of breakdown products derived from the perfusate. For example, species such as free haemoglobin and ammonia can accumulate to toxic concentrations over 24 hours of perfusion. Other key biochemical parameters, including sodium concentration, potassium concentration, and pH may also diverge from safe levels.

It is an object of the present disclosure to provide apparatus and methods that support improved ex-vivo perfusion of organs.

According to an aspect of the invention, there is provided an apparatus for performing ex-vivo perfusion of an organ, comprising: an organ receiving unit configured to receive an ex-vivo organ and provide fluidic connections to a vasculature of the received organ; a first conduit system configured to define a perfusate flow circuit including a flow path through the vasculature of the received organ; a perfusate pumping system configured to drive a circulatory flow of perfusate in the perfusate flow circuit and through the vasculature of the received organ; a second conduit system defining a dialysate flow circuit; a dialysate pumping system configured to drive a circulatory flow of a dialysate in the dialysate flow circuit; and a dialysis unit configured to process the perfusate using the dialysate, the dialysis unit comprising a membrane configured to contact the perfusate in the perfusate flow circuit on one side of the membrane and the dialysate in the dialysate flow circuit on the other side of the membrane, the membrane being configured to allow material to pass between the perfusate flow circuit and the dialysate flow circuit as a transmembrane flux.

Thus, an apparatus is provided that allows unwanted material in perfusate being used to perfuse an ex-vivo organ to be removed efficiently in an arrangement that can be implemented in compact form. Providing dialysate in a circulatory flow in a dialysate flow circuit avoids the need for continuous connection to a water supply and/or large volumes of water. Furthermore, the arrangement makes it possible to obtain useful information about the state of the organ being perfused by monitoring a composition of the dialysate in the dialysate flow circuit. Urea and bilirubin could be measured to monitor toxin accumulation for example (particularly with the liver). The measurements can be used to decide when to refresh the dialysate in the dialysate flow circuit (e.g., by replacing a bag of dialysate acting as a dialysate reservoir when it is deemed to have become too saturated, which may typically need to be done every couple of days). If a condition of the dialysate falls below a predetermined level a dialysate reservoir can be emptied and refilled or replaced with a new reservoir containing fresh dialysate. The ability to control flow in the dialysate flow circuit provides a high level of flexibility for controlling the perfusion process, for example by controlling the composition and/or volume of perfusate in the perfusate flow circuit.

In an embodiment, the apparatus further comprises a supplementary conduit and a supplementary dialysate pump, the supplementary dialysate pump being configured to pump dialysate via the supplementary conduit into the perfusate flow circuit upstream of the membrane of the dialysis unit. Providing a controllable supplementary path for injecting dialysate into the perfusate provides further flexibility for controlling the composition and/or volume of the perfusate during the perfusion process. This feature enhances the ability to control haemocrit, as well as providing flexibility for supporting other procedures such as flushing (and optionally cooling) of perfusate in preparation for transplantation or introducing (and optionally warming) perfusate when an organ is first connected to the apparatus.

In an embodiment, the apparatus comprises a dialysate flow controller configured to control flow of dialysate in the apparatus. In some embodiments, the dialysate flow controller is configured to control the transmembrane flux by controlling the flow of dialysate in the apparatus. Controlling the transmembrane flux makes it possible to control a composition of the perfusate in the perfusate flow circuit with a high degree of flexibility and accuracy. By controlling the transmembrane flux it is possible for example to move between different regimes of passage of entities from the perfusate to the dialysate. For example, at lower or zero transmembrane fluxes entities may pass through the membrane primarily or entirely by diffusion, whereas at higher transmembrane fluxes entities may additionally pass to a significant extent by entrainment by the flow. The latter mode may allow larger entities in the perfusate to pass into the dialysate. This may be desirable in certain circumstances but a balance may be needed to avoid unwanted loss of beneficial components from the perfusate, such as albumin.

In an embodiment, the apparatus comprises a dialysate reservoir connected within the dialysate flow circuit and configured to contain dialysate. The dialysate flow controller is configured to control the transmembrane flux at least partly by controlling a pressure of dialysate adjacent to the membrane in the dialysis unit. The dialysate pumping system comprises an upstream dialysate pump provided upstream of the dialysis unit in the dialysate flow circuit. The dialysate pumping system comprises a downstream dialysate pump provided downstream of the dialysis unit in the dialysate flow circuit. The dialysate flow controller is configured to control the pressure of dialysate adjacent to the membrane at least partly by controlling either or both of the upstream dialysate pump and the downstream dialysate pump. This approach provides a simple yet highly flexible and reliable way of controlling the transmembrane flux and, thereby, the composition and/or volume of perfusate flowing in the perfusate flow circuit.

In an embodiment, the dialysate flow controller is configured to control the supplementary dialysate pump as a function of the transmembrane flux. The dialysate flow controller may for example be configured to perform a volume compensation process by controlling the supplementary dialysate pump to reduce or avoid changes to the volume of the perfusate caused by the transmembrane flux. The control thus allows a volume of perfusate to be controlled (e.g., maintained constant) while allowing a finite transmembrane flux of material from the perfusate to the dialysate. The supplementary dialysate pump may also be controlled to support other procedures such as the flushing and/or introducing of perfusate mentioned above.

In an embodiment, the apparatus comprises a perfusate sensor configured to measure a target parameter of perfusate in the perfusate flow circuit. The target parameter may comprise haemocrit for example. The dialysate flow controller may control the transmembrane flux as a function of the measured target parameter. Thus, the apparatus may be configured to actively control the composition of the perfusate in response to measured properties of the perfusate. This ability makes it possible to control the quality of perfusate more reliably and flexibly, thereby contributing to safe preservation of the organ over longer time periods.

In an embodiment, the apparatus comprises a perfusate port configured to allow perfusate to be added to or removed from the perfusate flow circuit. The apparatus may use the perfusate port to perform a flushing process by progressively diluting the perfusate by providing a net flow of dialysate into the perfusate flow circuit via the supplementary conduit and a net flow of perfusate out of the perfusate flow circuit via the perfusate port.

Thus, the perfusate port and supplementary conduit can be used to support flushing of the organ prior to transfer out of the apparatus. In some embodiments, a temperature controller may be provided to cool perfusate during the flushing process.

In an embodiment, the apparatus is configured to perform a perfusate introduction process including progressively increasing a concentration of cellular matter in the perfusate by inputting cellular matter via the perfusate port and removing non-cellular matter as transmembrane flux into the dialysate flow circuit. Thus, the perfusate port and supplementary conduit can be used to support gradual introduction of appropriate perfusate to the organ. In some embodiments, a temperature controller may be provided to warm the perfusate during the perfusate introduction process.

In an embodiment, the perfusate flow circuit comprises a plurality of flow sections arranged in parallel. The plurality of flow sections comprise a primary flow section and a secondary flow section. The primary and secondary flow sections are provided in parallel with each other. The primary flow section is configured has a lower flow resistance than the second flow section (e.g., the primary flow section is configured to accommodate a larger flow than the secondary the flow section). The dialysis unit is connected within the secondary flow section. This approach provides an advantage of allowing the dialysis unit to present relatively high flow resistances to the perfusate flow circuit without requiring a corresponding increase in pumping power and/or pressures to achieve adequate perfusion of the organ. The perfusate pressure at the inlet to the perfusate flow circuit may, for example, be maintained in the region of 60-90 mmHg, which is significantly lower than perfusate inlet pressures typically used during dialysis, which may be in the range of 200-250 mmHg).

In an embodiment, the dialysis unit is connected within a flow section of the perfusate flow circuit that is configured to accommodate all or a majority of flow within the perfusate flow circuit. The dialysis unit may thus be provided in a series arrangement with no partially or completely bypassing parallel arrangement. This approach can be implemented more simply and compactly than alternative arrangements. In an embodiment, the dialysis unit is connected to the first conduit system and the second conduit system in such a way that a flow resistance presented to the first conduit system by the dialysis unit is lower than a flow resistance presented to the second conduit system by the dialysis unit. Thus, it is arranged that perfusate can flow more easily through the dialysis unit than dialysate. This approach facilitates provision of sufficient flow rates through the organ without requiring excessive pressures.

In an embodiment, the dialysate flow controller and/or dialysate pumping system is configured to drive the flow of the dialysate in such a way as to provide an alternating transmembrane flux, the alternating transmembrane flux alternating between a net transmembrane flux from the perfusate flow circuit to the dialysate flow circuit and a net transmembrane flux from the dialysate flow circuit to the perfusate flow circuit. The transmembrane flux may be biased to provide a non-zero transmembrane flux averaged over multiple cycles of the alternating transmembrane flux. Providing the alternating “push-pull” flux promotes improved (e.g., more consistent) removal of undesirable entities from the perfusate, such as free haemoglobin, via the transmembrane flux by reducing or avoiding blocking of pores of the membrane by red blood cells.

According to an additional aspect of the invention, there is provided a method of performing ex-vivo perfusion of an organ, comprising: connecting an organ in an ex-vivo state to an organ receiving unit; driving a circulatory flow of a perfusate in a perfusate flow circuit and through the organ; driving a circulatory flow of a dialysate in a dialysate flow circuit; and using a dialysis unit to process the perfusate using the dialysate, wherein the dialysis unit comprising a membrane that contacts the perfusate in the perfusate flow circuit on one side of the membrane and the dialysate in the dialysate flow circuit on the other side of the membrane, the membrane allowing material to pass between the perfusate flow circuit and the dialysate flow circuit as a transmembrane flux.

Embodiments of the disclosure will now be further described, merely by way of example, with reference to the accompanying drawings.

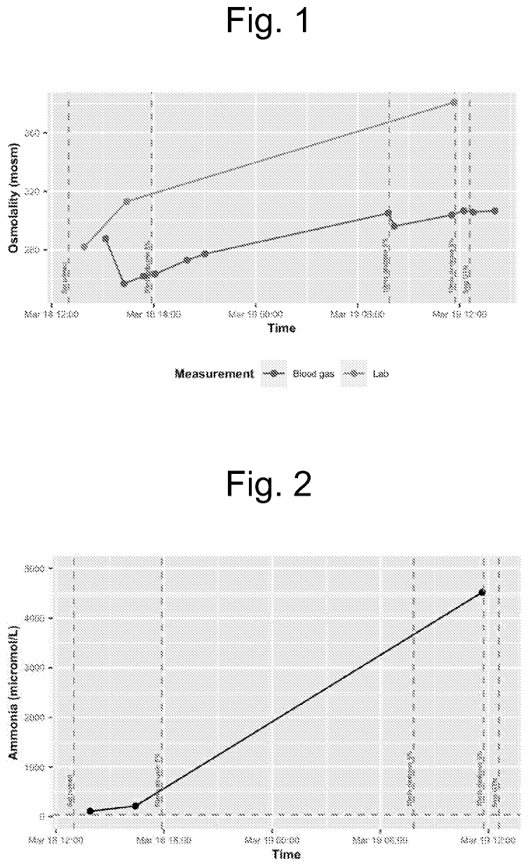

FIG. 1 is a graph showing variation of osmolality in perfusate as a function of time during perfusion of an organ using a prior art technique.

FIG. 2 is a graph showing variation of ammonia in perfusate as a function of time during perfusion of an organ using a prior art technique.

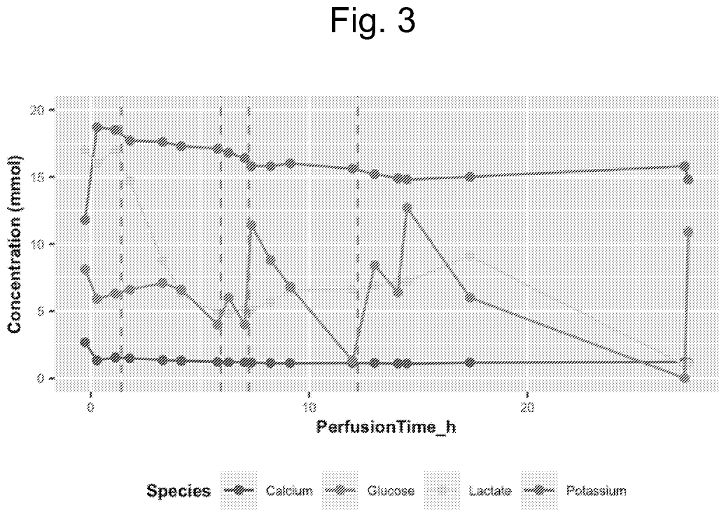

FIG. 3 is a graph showing variation of various biochemistry components in perfusate as a function of time during perfusion of an organ using a prior art technique.

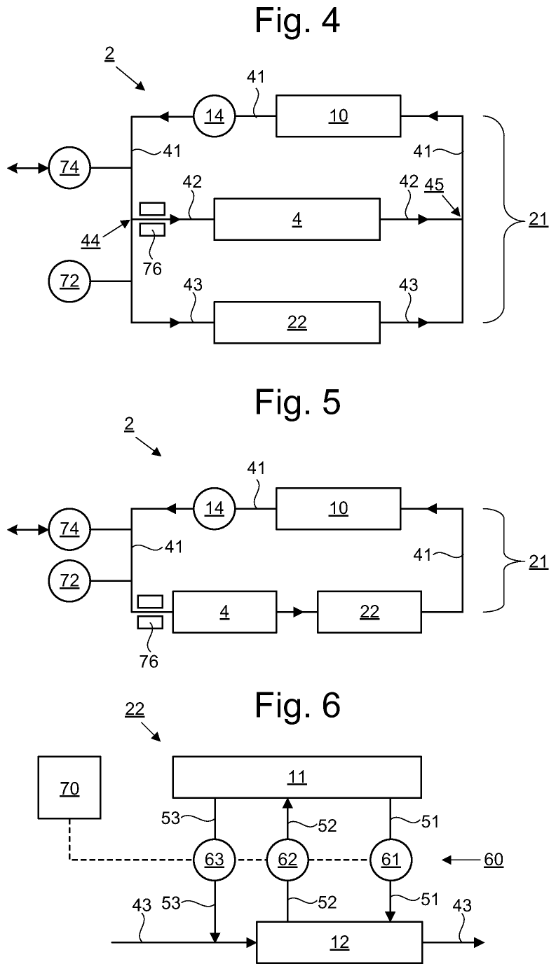

FIG. 4 schematically depicts an apparatus for ex-vivo perfusion of an organ in which a dialysis unit is provided in a parallel connection arrangement within a perfusate flow circuit.

FIG. 5 schematically depicts an apparatus for ex-vivo perfusion of an organ in which the dialysis unit is provided in a series connection arrangement within the perfusate flow circuit.

FIG. 6 schematically depicts a dialysate flow circuit.

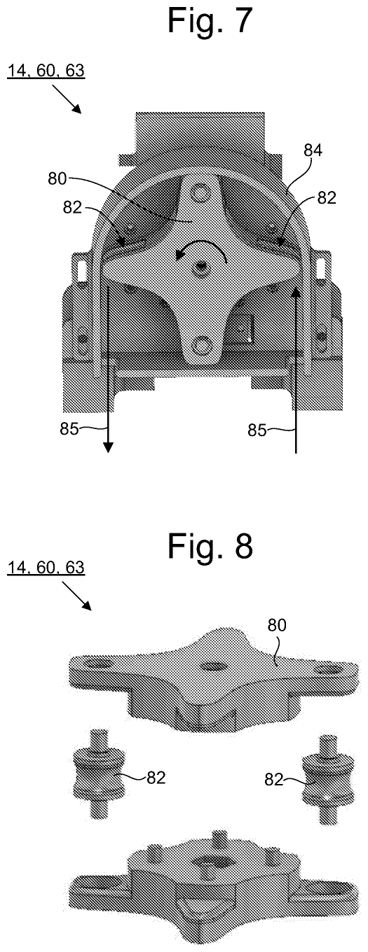

FIG. 7 is a schematic perspective view of an example pump for use in embodiments of the disclosure.

FIG. 8 is a schematic exploded perspective view of the example pump of FIG. 7.

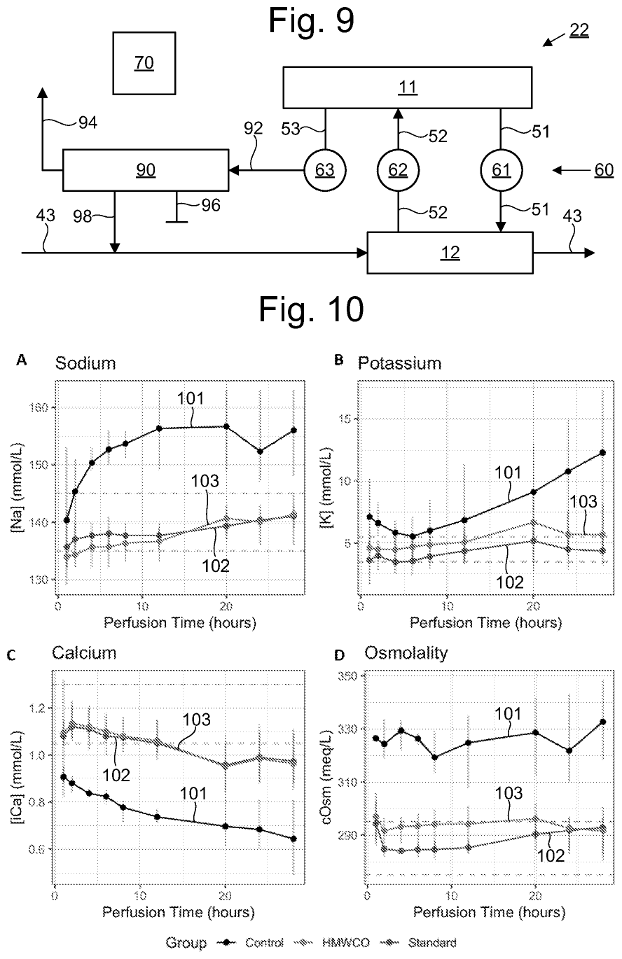

FIG. 9 schematically depicts a variation on the dialysate flow circuit of FIG. 6.

FIG. 10A-D are graphs showing electrolyte concentrations during ex-vivo liver perfusion under standard conditions (curves 101), with low cut-off recirculated haemodialysis (rHD) (curves 102), and high cut-off rHD (curves 103). Values shown are group means and ranges. FIG. 10A shows sodium concentration over time (normal range shown as 135-145 mmol/L). FIG. 10B shows potassium concentration over time (normal range shown as 3.5-5.5 mmol/L). FIG. 10C shows calcium concentration over time (normal range shown as 1.05-1.3 mmol/L). FIG. 10D shows calculated osmolality, with normal range shown as 275-295 mosm/L.

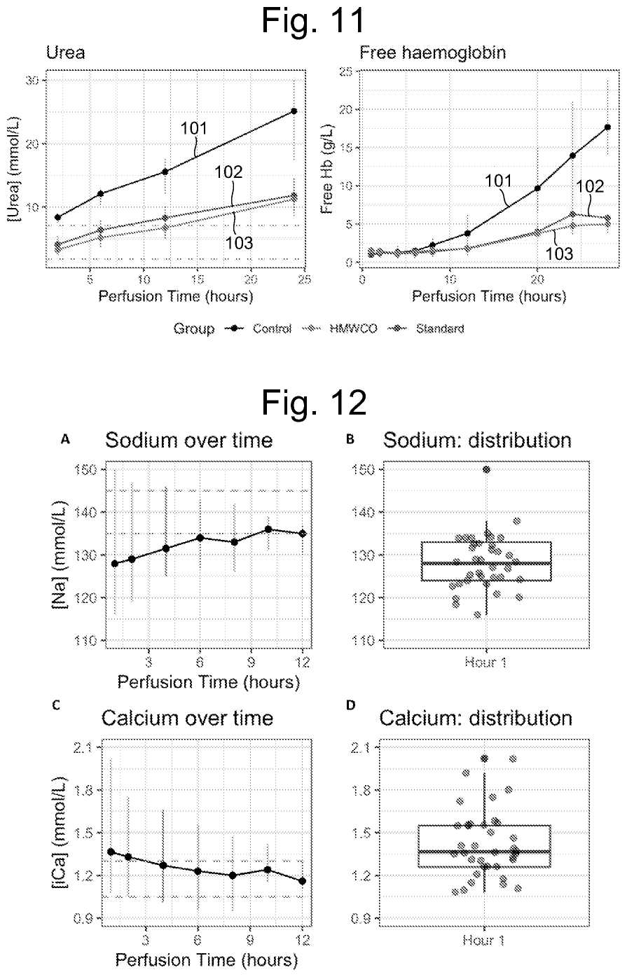

FIG. 11 shows graphs of metabolic waste (left graph; urea) and free haemoglobin (right graph; DAMP resulting from the effects of mechanical ex-vivo perfusion on erythrocytes) during perfusion under standard conditions (curves 101), with low cut-off rHD (curves 102), and high cut-off rHD (curves 103). Removal of urea by dilution with rHD can be seen. The effect on the rate of free haemoglobin generation was unexpected, and may relate to better control of osmolality rendering erythrocytes less susceptible to mechanical stress.

FIG. 12 are graphs showing electrolyte concentrations during clinical normothermic kidney perfusion prior to transplantation, conducted during NKP1. These perfusions were conducted with intensive manual electrolyte maintenance by means of frequent sampling and replace over sampling volume with electrolyte solutions. Dialysis was not used. FIGS. 12A and 12C show trends over time for sodium and calcium concentrations. FIGS. 12B and 12D show the high degree of variability between cases at the hour 1 timepoint. In particular, despite a standardised protocol, ionised calcium concentration varied by a factor of two between cases.

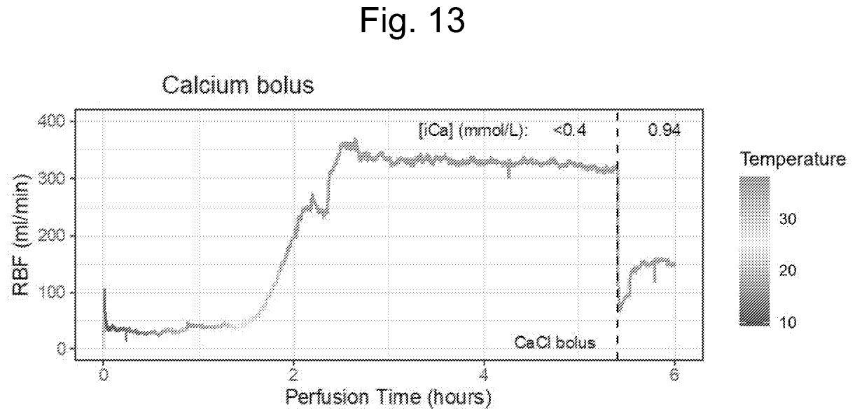

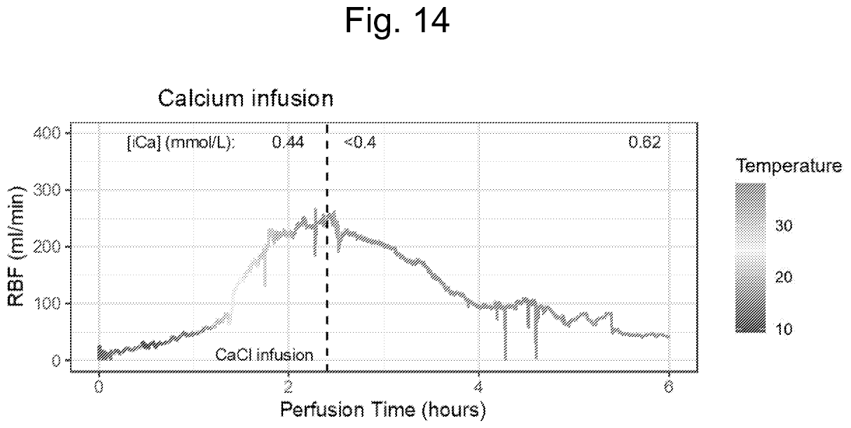

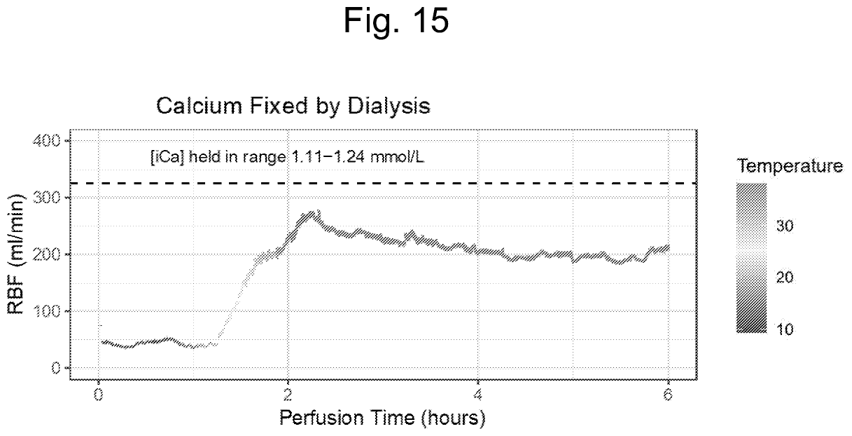

FIGS. 13-15 are graphs showing vascular instability in perfused porcine kidneys induced by hypocalcemia and subsequent correction. Perfused porcine kidneys undergoing gradual rewarming are highly susceptible to the adverse effects of calcium flux. FIG. 13 shows how standard dosing of calcium prior to organ connection and gradual rewarming results in severe hypocalcemia; correction by administration of a bolus dose induces immediate tetany. FIG. 14 shows terminal vasoconstriction not being avoided by slow administration of the corrective calcium dose. FIG. 15 shows perfusion failure due to vasoconstriction being prevented by maintenance of normal calcium throughout by means of dialysis.

As mentioned in the introductory part of the description, in the absence of features of the present disclosure, accumulation of metabolic waste and breakdown products from a perfusate can limit preservation times for organs undergoing ex-vivo perfusion. FIGS. 1-3 depict examples of such variations in perfusate composition with time during ex-vivo perfusion. FIG. 1 shows a variation of osmolality as a function of time, measured using different techniques. The “Blood gas” measurements were performed by a clinical blood gas analyzer, which are commonly found in clinical settings and provide ‘point-of-care’ immediate results. The ‘Lab’ measurements were performed by freezing point deflection. The blood gas analyzer measurements are substantially lower than the true (lab) measurements because they are an estimate calculated from measured parameters (e.g. sodium, glucose)—osmolality is not directly measured by a blood gas analyzer. The peculiarities of perfusate (e.g. accumulation of unusual metabolic waste—such as ammonia) mean that this ‘osmolar gap’ (difference between estimated and true values) is much wider for perfusate as compared to blood, and the gap increases with time. Therefore, assessment of this osmotic deterioration is underestimated by blood gas analysis. FIG. 2 shows a variation of ammonia levels as a function of time. FIG. 3 shows a variation of various biochemistry components as a function of time. In all cases, significant deteriorations and/or variability are seen, which would limit maximum preservation time. Furthermore, the observed behaviour is highly dependent on the starting conditions such as the age of the stored blood used to provide the perfusate. This leads to unpredictability in outcomes. The present disclosure describes apparatus and methods that provide greater control over perfusate composition and reliably allow organs to be preserved in an ex vivo state for longer periods of time.

FIGS. 4-6 depict example configurations of an apparatus 2 for performing ex-vivo perfusion of an organ according to the present disclosure.

The apparatus 2 comprises an organ receiving unit 4. The organ receiving unit 4 is configured to receive an ex-vivo organ and provide fluidic connections to a vasculature of the received organ. The ex-vivo organ may comprise a liver, a kidney, or another organ of a human or animal. The connection to the vasculature is such as to allow a perfusate to be driven through the organ to perfuse the organ and preserve the organ in a healthy state. The perfusate will typically comprise blood. The terms perfusate and blood may be used interchangeably within the present disclosure except in special situations such as where the perfusate is undergoing a flushing process in preparation for removal of the organ or a perfusate introduction process when the organ is first introduced to the apparatus. In these special situations the perfusate may be significantly diluted relative to normal blood composition.

The apparatus 2 comprises a first conduit system, exemplified in FIGS. 4 and 5. The first conduit system defines a perfusate flow circuit 21. Example conduits of the first conduit system are labelled 41-43. The first conduit system may comprise any suitable combination of conduits (e.g., tubes), connectors, valves, etc. necessary to direct a flow of perfusate in the manner required. The perfusate flow circuit 21 includes a flow path through the vasculature of the received organ. The apparatus 2 further comprises a perfusate pumping system 14 configured to drive a circulatory flow (circulation) of perfusate in the perfusate flow circuit 21 and through the vasculature of the received organ. The vascular system of the organ may thus be considered as forming part of the perfusate flow circuit 21 when the organ is connected to the organ receiving unit 4.

The apparatus 2 may further comprise a perfusate reservoir 10 connected within the perfusate flow circuit 21. The perfusate reservoir 10 contains perfusate. Various sub-units may be provided to process the perfusate as it flows in the perfusate flow circuit 21 to mimic processes that would occur in the body. These sub-units may include for example a gas exchange system to replenish oxygen in the perfusate and remove carbon dioxide. Any of various known oxygenators can be used, such as those designed for cardiopulmonary bypass operations or extracorporeal membrane oxygenation, ECMO. Nutrients such as glucose may also be supplied to the perfusate.

The apparatus 2 further comprises a second conduit system. An example arrangement is depicted in FIG. 6. The second conduit system defines a dialysate flow circuit 22. Example conduits of the second conduit system are labelled 51-53 in FIG. 6. The second conduit system may comprise any suitable combination of conduits (e.g., tubes), connectors, valves, etc. necessary to direct a flow of dialysate in the manner required. The apparatus further comprises a dialysate pumping system 60. The dialysate pumping system 60 is configured to drive a circulatory flow (circulation) of a dialysate in the dialysate flow circuit 22. The apparatus 2 may comprise a dialysate reservoir 11 connected within the dialysate flow circuit 22. The dialysate reservoir 11 contains dialysate. In some embodiments, the dialysate reservoir 11 is configured to be detachably connected to the dialysate flow circuit 22 (e.g., via valves that can be opened and closed). This allows the dialysate reservoir 11 to be exchanged during use to refresh the dialysate. The dialysate flow circuit 22 is a closed circuit. The quantity of dialysate in the dialysate flow circuit 22 thus remains approximately constant during use, except optionally during refreshment of the dialysate reservoir 11 by emptying and refilling or replacement. A total volume of dialysate in the dialysate flow circuit 22 may be in the range of 1-10 L, for example about 5 L (which corresponds to the size of a commercially available bag of dialysate and so may be particularly convenient).

The dialysate may have any of various known formulations suitable for dialysate. Various possibilities exist but the following constituents are typically constant between different formulations (sodium 140 mmol/L, calcium 1.5 mmol/L, magnesium 0.5 mmol/L, bicarb 35 mmol/L, glucose 5.55 mmol/L). A constituent that varies between different compositions is potassium, where there typically a choice between about 0-4 mmol. Higher levels of potassium will typically work best for embodiments of the present disclosure, so formulations having potassium at 3 or 4 mmol/L levels may desirably be selected.

The apparatus 2 further comprises a dialysis unit 12. The dialysis unit 12 processes the perfusate using the dialysate. The dialysis unit 12 comprises a membrane that contacts the perfusate in the perfusate flow circuit on one side of the membrane and the dialysate in the dialysate flow circuit on the other side of the membrane. The membrane thus simultaneously contacts perfusate and dialysate on different sides of the membrane. The membrane provides a mechanical separation between the perfusate and dialysate. The membrane allows material to pass between the perfusate flow circuit and the dialysate flow circuit as a transmembrane flux. The membrane may thus be porous and/or otherwise allow selected components of the respective liquids to pass through the membrane. For example, metabolic waste and breakdown products may pass from the perfusate to the dialysate through the membrane. In some embodiments, the dialysis unit 12 comprises a cartridge configured to perform a dialysis process for a human undergoing dialysis treatment. Various known types of such cartridge may be used. For example, a cartridge configured for use in expanded haemodialysis (HDx) may be used. Cartridges of this type may comprise a membrane configured to improve clearance of uremic toxins in the range 5-50 kDa relative to cartridges for standard haemodialysis (HD). Thus, embodiments of the present disclosure may comprise a membrane in the dialysis unit 12 that is configured to promote clearance of uremic toxins in the range 5-50 kDa.

In some embodiments, the dialysis unit 12 comprises a plurality of narrow tubes configured to accommodate a flow of perfusate through the dialysis unit 12 and a flow arrangement configured to allow a flow of dialysate adjacent to the narrow tubes (e.g., in the opposite sense to the flow of perfusate). In such an arrangement, the membrane would form part or all of the structure defining the narrow tubes. Plural membranes may thus be present in the dialysis unit 12. The perfusate flow circuit 21 and the dialysate flow circuit 22 are configured to substantially prevent flow of cellular components of the perfusate (e.g., red perfusate cells, etc.) from the perfusate flow circuit 21 to the dialysate flow circuit 22. For example, the perfusate flow circuit 21 and the dialysate flow circuit 22 may be configured so that they contact each other only via one or more of the membranes and the membranes are configured to substantially block passage of cellular components.

In the example of FIG. 4, a parallel connection arrangement is provided in which the perfusate flow circuit 21 comprises a primary flow section and a secondary flow section connected in parallel with each other. In the example shown in FIG. 4, the primary flow section comprises conduits 42 and the secondary flow section comprises conduits 43. The primary and secondary flow sections are thus provided between a first branching point 44 where a flow in conduit 41 splits into two flows along conduits 42 and 43 and a second branching point 45 where the flows from conduits 42 and 43 join together again and flow into conduit 41. The flow in the primary flow section is thus in parallel with the flow in the secondary flow section. The primary flow section is configured to accommodate a larger flow than the secondary flow section. The flow resistance of the primary flow section may thus be lower than the flow resistance in the secondary flow section. In an arrangement of this type, the dialysis unit 12 (connected within the dialysate flow circuit 22) is connected within the secondary flow section.

In embodiments where the dialysis unit 12 comprises narrow tubes for the perfusate flow that have a relative high flow resistance, it may be more appropriate to use the parallel connection arrangement of FIG. 4 so that an adequate flow of perfusate through the organ can be achieved without requiring unnecessarily high pressures in the perfusate flow circuit 21.

In the example of FIG. 5, a series connection arrangement is provided in which the dialysis unit 12 (connected with the dialysate flow circuit 22) is connected within a flow section of the perfusate flow circuit 22 that is configured to accommodate all or a majority of flow within the perfusate flow circuit 21. In arrangements of this type, the dialysis unit 10 may be connected to the first conduit system and the second conduit system in such a way that a flow resistance presented to the first conduit system by the dialysis unit 12 is lower than a flow resistance presented to the second conduit system by the dialysis unit 12. This may be the case for example where a cartridge intended for a dialysis machine is used with the connections reversed such that perfusate flows through the dialysate channels and dialysate flows through the perfusate channels. In such cartridges the flow resistance of the dialysate channels will usually be considerably lower than the flow resistance of the perfusate channels.

As exemplified in FIG. 6, in some embodiments the dialysate pumping system 60 comprises an upstream dialysate pump 61 provided upstream of the dialysis unit 12 in the dialysate flow circuit 22. The upstream dialysate pump 61 interacts with the circulatory flow in a flow path between the dialysate reservoir 11 and the dialysis unit 12. The upstream dialysate pump 61 may thus be provided in the flow path between the dialysate reservoir 11 and the dialysate unit 12. In the example shown, this flow path is defined by a conduit 51 of the second conduit system. The dialysate pumping system 60 further comprises a downstream dialysate pump 62 provided downstream of the dialysis unit 12 in the dialysate flow circuit 22. The downstream dialysate pump also interacts with the circulatory flow in a flow path between the dialysate reservoir 11 and the dialysate unit 12. In the example shown, this flow path is defined by a conduit 52 of the second conduit system.

As exemplified in FIG. 6, in some embodiments the apparatus 2 further comprises a supplementary conduit 53 and a supplementary dialysate pump 63. The supplementary dialysate pump 63 pumps dialysate via the supplementary conduit 53 into the perfusate flow circuit 22 upstream of the membrane of the dialysis unit 12. In the example shown, the supplementary conduit 53 fluidically connects the dialysate reservoir 11 to a conduit 43 of the perfusate flow circuit 21. Thus, in contrast to the situation in the dialysis unit 12 where material can only pass between the perfusate flow circuit 21 and the dialysate flow circuit 22 as transmembrane flux, dialysate can pass directly from the dialysate flow circuit 22 into the perfusate flow circuit 21 via the supplementary conduit 53.

As exemplified in FIG. 6, in some embodiments the apparatus 2 further comprises a dialysate flow controller 70. The dialysate flow controller 70 controls flow of dialysate in the apparatus 2. The dialysate flow controller 70 may thus be configured to control any element of the apparatus 2 that can affect flow of dialysate. As described below, the dialysate flow controller 70 may be configured particularly to control dialysate flow in such a way as to control the transmembrane flux. The dialysate flow controller 70 may be implemented using any suitable combination of hardware, firmware and/or software capable of providing the desired data processing and/or communications functionality. Data connections, indicated schematically by broken lines in FIG. 6, may be provided to allow the dialysate flow controller 70 to communicate with elements that are controlled by the dialysate flow controller 70 and/or which provide information (e.g., sensor outputs) to the dialysate flow controller 70 that may be used to support the desired control.

In some embodiments, the apparatus 2 comprises a perfusate sensor 72. The perfusate sensor 72 measures one more target parameters of perfusate in the perfusate flow circuit 21. The dialysate flow controller 70 may be configured to receive data representing an output from the perfusate sensor 72. The target parameter may comprise haemocrit for example. Haemocrit represents a relative amount of red blood cells in perfusate. Haemocrit may be quantified for example as the calculated volume percentage of red blood cells. Any of various known approaches for measuring haemocrit may be used, including for example via haemoglobin spectroscopy, via centrifugation, via Coulter impedance principle measurements, or via perfusate gas analysis.

In some embodiments, the dialysate flow controller 70 is configured to control the transmembrane flux as a function of (e.g., in response to) the measured target parameter. For example, the dialysate flow controller 70 may be configured to control the transmembrane flux in response to the measured haemocrit of perfusate in the perfusate flow circuit 21.

In some embodiments, the dialysate flow controller 70 is configured to control the transmembrane flux to maintain the target parameter (e.g., haemocrit) within a predetermined range of a target value. The target value may comprise a physiologically normal or average value of the target parameter. The predetermined range may correspond to a range around the physiologically normal or average value within which damage to the organ will be acceptably low or negligible.

In some embodiments, the dialysate flow controller 70 controls the transmembrane flux at least partly by controlling a pressure of dialysate adjacent to the membrane in the dialysis unit 12. This may be achieved for example by controlling either or both of the upstream and downstream dialysate pumps 61, 62. For example, by increasing a pumping rate of the upstream dialysate pump 61 relative to the downstream dialysate pump 62 it is possible to increase a pressure of the dialysate in a portion of the dialysate flow circuit adjacent to (e.g., contacting) the membrane. Conversely, decreasing a pumping rate of the upstream dialysate pump 61 relative to the downstream dialysate pump 62 will decrease a pressure of the dialysate in the portion of the dialysate flow circuit 22 adjacent to (e.g., contacting) the membrane. Increasing a pressure of dialysate in the dialysate flow circuit 22 adjacent to the membrane will tend to decrease the transmembrane flux from the perfusate flow circuit 21 to the dialysate flow circuit 22. Decreasing a pressure of dialysate in the dialysate flow circuit 22 adjacent to the membrane will tend to increase the transmembrane flux from the perfusate flow circuit 21 to the dialysate flow circuit 22.

In some embodiments, the dialysate flow controller 70 is configured to control the supplementary dialysate pump 63 as a function of the transmembrane flux. For example, the dialysate flow controller 70 may perform a volume compensation process by controlling the supplementary dialysate pump 63 to reduce or avoid changes to the volume of the perfusate in the perfusate flow circuit 21 caused by the transmembrane flux. For example, the volume of perfusate in the perfusate flow circuit 21 can be kept substantially constant by controlling the supplementary dialysate pump 63 to inject dialysate into the perfusate flow circuit 21 at a rate that is equal to the rate at which material leaves the perfusate flow circuit 21 as transmembrane flux in the dialysis unit 12. Purely as an example, in one configuration where pumps 61-63 are identical and configured as described below with reference to FIGS. 7 and 8 such that flow rate is proportional to pump rotation rate, the upstream dialysate pump 61 was controlled to rotate at 42 rpm, the downstream dialysate pump 62 was controlled to rotate at 55 rpm and the supplementary dialysate pump 63 was controlled to rotate at 13 rpm to make up the difference. This arrangement provided a constant transmembrane flux while also maintaining a constant volume of perfusate in the perfusate flow circuit 21. The dialysate flow controller 70 may alternatively be configured to selectively adjust the volume of perfusate in the perfusate flow circuit 21, which may be provide by adjusting the transmembrane flux and/or the rate of flow of dialysate into the perfusate flow circuit 21 via the supplementary conduit 53. In one example implementation, in a case where the target parameter comprises haemocrit, the dialysate flow controller 70 may be configured to respond to a case where the measured haemocrit is above a first predetermined threshold by decreasing a net transmembrane flux from the perfusate flow circuit 21 to the dialysate flow circuit 22 and/or increasing a rate of flow of dialysate into the perfusate flow circuit 21 via the supplementary conduit 53. Conversely, the dialysate flow controller 70 may be configured to respond to a case where the measured haemocrit is below a second predetermined threshold by increasing a net transmembrane flux from the perfusate flow circuit 21 to the dialysate flow circuit 22 and/or decreasing a rate of flow of dialysate into the perfusate flow circuit 21 via the supplementary conduit 53.

In some embodiments, as exemplified in FIGS. 4 and 5, the apparatus 2 comprises a perfusate port 74 configured to allow perfusate to be added to or removed from the perfusate flow circuit 21.

The apparatus 2 may be configured to a flushing process by progressively diluting the perfusate. The progressive dilution may be achieved by providing a net flow of dialysate into the perfusate flow circuit 21 via the supplementary conduit 53 and a net flow of perfusate out of the perfusate flow circuit 21 via the perfusate port 74. Such a flushing process is desirable after normothermic machine perfusion, where organs are typically ‘cold-flushed’ in preparation for implantation—i.e. the blood is removed by flushing them through with a cold solution.

The apparatus 2 may be configured to perform a perfusate introduction process including progressively increasing a concentration of cellular matter in the perfusate in the perfusate flow circuit by inputting cellular matter to the perfusate flow circuit via the perfusate port and removing non-cellular matter from the perfusate flow circuit as transmembrane flux into the dialysate flow circuit. This process may be seen as the complement of the flushing process described above and is typically performed at the start of perfusion. For example, perfusion may be started with cold, acellular, oxygenated perfusate and after a period of time with the perfusate at a temperature in the range of 15-18 degrees, red blood cells are progressively added while also progressively increasing the temperature until 37 degrees is reached. The apparatus 2 can implement this process in a highly controlled manner because of the way the overall volume of the perfusate can be controlled (e.g., via the upstream and downstream dialysate pumps 61, 62 and/or the supplementary dialysate pump 63). For example, as the red cells are added, volume can be progressively removed from the perfusate flow circuit 21 by setting a large transmembrane flux, and/or low or no input of dialysate via the supplementary conduit 53, to create space for the red blood cells.

In some embodiments, as exemplified in FIGS. 4 and 5, the apparatus 2 comprises a temperature controller 76. The temperature controller 76 interacts with the perfusate in the perfusate flow circuit to apply heating or cooling. In the case where the above-described flushing process is performed, for example, the temperature controller 76 may cool the perfusate during the flushing process. In the case where the above-described perfusate introduction process is performed, for example, the temperature controller 76 may warm the perfusate during the flushing process. The temperature controller 76 may additionally or alternatively be used to compensate for heat losses during steady state operation and ensure that perfusate enters the organ at the correct temperature. In some embodiments, the temperature controller 76 is configured to interact with perfusate upstream of the organ receiving unit 4.

Any of various known types of pump may be used to implement the perfusate pumping system 14, the dialysate pumping system 60 and/or the supplementary dialysate pump 63 referred to above. An example embodiment is shown in FIGS. 7 and 8. A flexible tube (not shown) containing the liquid to be pumped would be thread in a U-shape so as to be supported on its radially outer surface by an inner surface of the curved casing 84 and to be pressed against by rollers 82 on portions of the radially inner surface of the tube. The tube is thus pinched between the curved casing 84 and the rollers 82 at the positions of the rollers 82. Rotation of the body 80 holding the rollers 82 relative to the curved casing 84 drives flow of the liquid in the tube in the sense indicated by arrows 85. This type of pumping arrangement may be referred to as an occlusive roller pump. The flow rate driven by the pump is proportional to the rate of rotation of the pump (i.e., the rate of rotation of the body 80 holding the rollers 82). The flow rate can thus be measured by measuring the rate of rotation of the pump. Various techniques may be used to measure the rate of rotation of the pump. In one class of embodiment, one or more magnets is/are provided in the body 80 and a Hall effect sensor mounted fixedly with respect to the curved casing 84 is used to detect passing of the magnet(s), from which the rate of rotation can be derived.

In some arrangements, the dialysate flow controller 70 and/or dialysate pumping system 60 is or are configured to drive the flow of the dialysate in such a way as to provide an alternating transmembrane flux. The alternating transmembrane flux alternates between a net flux from the perfusate flow circuit 21 to the dialysate flow circuit 22 and a net flux from the dialysate flow circuit 22 to the perfusate flow circuit 21. The alternating transmembrane flux may be described as a “push-pull” mode or action. In some examples, the alternating transmembrane flux is biased to provide a non-zero transmembrane flux averaged over multiple cycles of the alternating transmembrane flux. In one particular arrangement, as discussed in the Demonstration of Performance section below, the alternating transmembrane flux is implemented by suitable programming of the upstream and downstream dialysate pumps 61 and 62. For example, the pumps 61 and 62 may be configured to operate for a first predetermined time period (e.g., in the range of 100 ms to 500 ms, for example 300 ms) at a higher speed and a second predetermined time period (e.g., in the range of 500 ms to 1000 ms, for example 700 ms) at a lower speed, out of phase with each other (i.e., such that pump 61 is operating at the higher speed while pump 62 is operating at the lower speed and vice versa). The transmembrane flux may thus be arranged to alternate in one second cycles (700 ms in one direction and 300 ms in the other direction). By arranging for the higher speed and/or lower speed of pump 61 to be different from the respective higher speed and/or lower speed of pump 62 it is possible to provide the non-zero transmembrane flux averaged over multiple cycles. Typically, the average pumping speed will be arranged to be higher for the downstream (efflux) pump 62 than for the upstream (influx) pump 61 to encourage a net transmembrane flux from the perfusate flow circuit 21 to the dialysate flow circuit 22. As described above, the supplementary dialysate pump 63 can be programmed to make up the difference in volume by providing a flow of liquid into the perfusate flow circuit 21 upstream of the dialysis unit 12 that is equal to the net transmembrane flux out of the perfusate flow circuit 21 (e.g., based on a measured average difference between efflux/influx).

The inventor has demonstrated that the push-pull mode promotes improved (e.g., more consistent) removal of undesirable entities from the perfusate, such as free haemoglobin, via the transmembrane flux. The improved performance is thought to arise due to a reduction or avoidance of blocking of pores in the membrane by migration of red blood cells onto the membrane that does not occur, or occurs less, when the push-pull mode is implemented in comparison to when the transmembrane flux occurs in the same direction for a long period of time. The push-pull mode is thought to encourage red cells to remain within faster flowing regions of flow away from the membrane rather than migrating towards the membrane.

FIG. 9 depicts a variation on the arrangement described above with reference to FIG. 6 that works particularly well in arrangements configured to implement the push-pull mode. In the arrangement of FIG. 9, the apparatus comprising a return filter 90. The return filter 90 is configured to filter dialysate prior to the dialysate being pumped from the supplementary conduit 53 into the perfusate flow circuit 21 upstream of the membrane of the dialysis unit 12 by the supplementary dialysate pump 63. In the example shown, the return filter 90 is positioned in a flow path between the dialysate reservoir 11 and the conduit 43 of the perfusate flow circuit 21. The return filter 90 may be configured to act as a finer filter than the membrane of the dialysis unit 12. The return filter 90 may thus be referred to as a low-cut off filter. The dialysis unit 12 may be referred to as a high-cut off filter. The return filter 90 may have any of the configurations discussed herein for the dialysis unit 12 except for having a membrane with smaller pores. The return filter 90 allows liquid to be returned to the perfusate without larger species (such as free haemoglobin) that have been removed via the transmembrane flux being undesirably reintroduced. The return filter 90 may comprise a blood-side inlet 92. The blood-side inlet 92 guides liquid from the supplementary dialysate pump 63 to the return filter 90. The return filter 90 may comprise a blood-side outlet 94. The blood-side outlet 94 may comprise a pinch valve. The blood-side outlet 94 may be configured to allow venting of small volumes of highly concentrated effluent if desired (e.g., for sampling). The return filter 90 may comprise a dialysate-side inlet 96, which in the configuration shown is capped (closed off). The return filter 90 comprises a dialysate-side outlet 98 that feeds into the conduit 43 of the perfusate flow circuit 21.

### Demonstration of Performance

Normothermic machine perfusion (NMP) of the liver is a standard technique for organ preservation and assessment prior to transplant. The OrganOx metra is a CE marked, FDA approved platform for NMP of the liver. Perfusion protocols in clinical use typically make use of three units of packed red cells, human albumin or gelofusin to provide oncotic pressure, various bolus solutions and drugs added prior to perfusion starting, and continuous infusions running during perfusion. This approach does not allow precise control of electrolytes, concentrations of which vary widely dependent on factors including the organ, the fluid it has been flushed with, and the age and composition of the stored red cells. For example, potassium concentration is frequently high due to UW solution present in the intravascular compartment of the liver following retrieval, and due to the extracellular potassium present in units of stored red cells. One possible solution to this is washing the red cells prior to use; however this is logistically difficult and anecdotally has resulted in severe on-circuit hypokalaemia. The effects of profoundly abnormal electrolyte concentrations aside, biochemical aberrations result in an inability to accurately measure lactate concentration using a standard blood gas analyser, which is a key metric of organ viability.

Other biochemical species are likely to accumulate as a consequence of normal metabolic function of the organ, and the isolated nature of ex-vivo perfusion. For example, in the absence of a kidney, an ex-vivo perfused liver may accumulate urea. Higher molecular weight species indicating damage (Damage Associate Molecular Patterns, DAMPS) are likely to accumulate, particularly with long-duration perfusions. Haemolysis is an inevitable consequence of prolonged ex-vivo perfusion due to the mechanical properties of the blood pump, non-biological nature of the silicone tubing, and lack of a full reticulo-endothelial system to remove damaged erythrocytes, or those nearing the end of their lifespan. The dialysis platform can be used to normalise the biochemical milieu of a perfusing liver. Dependent on the choice of filter, it may be possible to clear higher molecular-weight metabolic waste, and DAMPs.

There is increasing interest in applying normothermic machine perfusion technology to the kidney, as well as the liver. A phase 1 clinical trial investigating prolonged NMP of the kidney prior to transplantation has been completed and provides insight into the biochemical behaviour of the isolated perfused kidney. Whilst there are likely to be some differences between the liver and the kidney, many of the challenges (particularly control of electrolytes, fluid status, DAMPs, and haemolysis) are common and it is possible that use of a recirculated dialysis system may be of benefit.

The present disclosure presents apparatus and methods for performing ex-vivo perfusion in an improved manner. A series of organ perfusion experiments has been conducted to demonstrate efficacy of these apparatus and methods in normalisation of electrolytes, accurate control of fluid volume status, and removal of toxic species including metabolic waste, and damage-associated molecular patterns resulting from the process of perfusion. Methods and results are described below.

### Methods-Dialysis

Circuits were provided in which perfusate enters a dialysis system after a centrifugal blood pump of the metra (at a pressure of approximately 80 mmHg) and returns to the standard circuit via the portal venous reservoir. Dialysate enters and leaves the dialysis filter (dialysis unit 12) on the opposite side of the membrane, running in the opposite direction to the perfusate. Dialysate is pumped on the inflow and outflow, and transmembrane flux is determined by adjusting these rates. Predilution is administered by a third pumped line (supplementary conduit 53) joining the blood inflow, and is used to replace volume lost due to transmembrane flux, or otherwise add volume to the circuit as required. Dialysate is recirculated and may be replaced as it approaches saturation.

### Methods—Liver Perfusion

Normothermic machine perfusion of a series of nine DCD porcine livers were perfused using the OrganOx metra platform. Three were perfused in each group: (1) controls, perfused using leucocyte depleted blood and no dialysis; (2) using continuous/recirculated dialysis (rHD) with a standard dialysis filter (in dialysis unit 12); (3) using rHD with a high molecular weight cut-off filter (in dialysis unit 12). The priming volume of the liver perfusion circuit is approximately 1.5 L; the dialysate volume used is 5 L. A slaughterhouse liver procurement method was used, with warm ischaemic times all below 20 minutes and cold ischaemic times (before ex-vivo normothermic machine perfusion) below eight hours. Samples of perfusate were drawn at regular timepoints for analysis. Electrolyte concentrations (sodium, potassium, chloride, lactate, bicarbonate), haemoglobin concentration (total, and percent by species) and pH were assessed using an ABL-FLEX 90 benchtop blood gas analyser (BGA) and were measured at the time the sample was drawn. Remaining sample volume was immediately centrifuged for 15 minutes at 1800 g. A sample of the resulting supernatant was analysed using the BGA to determine cell-free haemoglobin concentration as an indicator of haemolysis. The remainder of the sample was frozen in liquid nitrogen and stored at −80° C. for further analysis. Samples of dialysate were also taken periodically for analysis. SDS-PAGE was performed for perfusate supernatant and dialysate samples to identify the molecular weights of the proteins present in each sample. Coomassie Blue was used to stain the final gel.

### Methods-Kidney Perfusion

Data derived from a 36-patient normothermic kidney perfusion trial (NKP1) was analysed to determine electrolyte behaviour under standard conditions (i.e. without dialysis, but with intensive electrolyte management by manual addition of bolus solutions to replace sampling volume). These samples were taken during clinical perfusions and immediately analysed using a clinical ABL-FLEX 90 benchtop blood gas analyser. Additional sample volume was centrifuged as above, with the supernatant analysed by means of the BGA to determine cell-free haemoglobin concentration.

Additional kidney perfusion experiments were performed using porcine kidneys retrieved in the same manner as the slaughterhouse livers described above, and perfused using clinical grade perfusion machines and disposable sets. These porcine kidneys all experienced warm ischaemic times of less than 20 minutes, before cold-flush with University of Wisconsin solution and hypothermic machine perfusion for up to 4 hours before connection to the normothermic perfusion machines. Total preservation time before initiation of NMP was less than 5 hours in all cases. These perfusion experiments were conducted in pairs, comparing results from the application of the NKP1 protocol to an adjusted protocol involving gradual rewarming. Dialysis was applied during the rewarming procedure in order to stabilise electrolyte concentrations.

### Results

Application of methods of the present disclosure (rHD) is shown to result in normalisation of key electrolytes including sodium, potassium, and calcium during ex-vivo normothermic liver perfusion (FIGS. 10A, 10B, 10C). This is reflected by controlled osmolality (FIG. 10D) with both standard and high molecular weight cut-off rHD. This observation contrasts with results obtained during standard perfusion, where electrolyte concentrations rapidly became significantly abnormal, and further deteriorated with time.

FIG. 11 shows the effect of methods of the present disclosure (rHD) on accumulation of metabolic waste (urea), and on free haemoglobin. Free haemoglobin indicates haemolysis caused by mechanical shear stress experienced by red blood cells during the process of ex-vivo perfusion. rHD notably reduced the rate of haemolysis regardless of filter pore size, which was unexpected. Without wishing to be bound by theory, it is believed that this may be the case because the better control of perfusate osmolality (FIG. 10D) renders erythrocytes less susceptible to the effects of mechanical shear stress.

Results from NKP1 illustrate electrolyte behaviour and control during prolonged-duration normothermic kidney perfusion under clinical conditions, without dialysis (FIG. 12). Whilst implementation of a standardised protocol does result in average sodium and calcium concentrations being within the target range, these averages mask substantial case-to-case variability (FIGS. 12B and 12D). This arises principally from natural variation in the constituents of a unit of packed red cells. Of particular note was the spread in the observed concentration of ionised calcium, which varied by two-fold at hour 1, despite all kidneys receiving the same starting dose of calcium.

In-vitro measurement of ionised calcium concentration in aliquots of standard perfusate with and without red cells revealed a significant effect of incubation time and temperature on observed calcium concentration when red cells are present, but not without (Table 1), supporting the hypothesis that resultant perfusate ionised calcium concentration is to an extent dependent on the metabolic activity of red cells. Porcine kidney perfusions revealed that avoidance of hypocalcemia is of critical importance; once severe hypocalcemia has occurred, it is not possible to correct without inducing irreversible tetanic vasoconstriction (FIGS. 13 and 14). Continuous application of methods of the present disclosure (rHD) prevents the development of hypocalcemia and maintains ionised calcium concentration in a tight range irrespective of other perfusate components, and the addition of red cells (FIG. 15). Use of rHD also permits tight volume control-during this experiment set volume could be precisely maintained by removing fluid using the machine during the additional of red cells, to maintain overall volume neutrality.

TABLE 1
ionised calcium concentration is dependent on temperature
and duration of incubation only when red cells are present

| | | | |
|---|---|---|---|
| Variable | Coefficient | p-value | Significance |

Model: ca ~ starting concentration + duration + temp (red cells present)

| | | | |
|---|---|---|---|
| Starting concentration | 0.73 | 9.13e−11 | *** |
| Duration | −0.006 | 0.045 * | * |
| Temperature | 0.02 | 0.039 * | * |

Model: ca ~ starting concentration + duration + temp (red cells absent)

| | | | |
|---|---|---|---|
| Starting concentration | 0.712913 | 6.73e−15 *** | *** |
| Duration | −0.003 | 0.444 NS | NS |
| Temperature | −0.0002 | 0.983 NS | NS |

The organ perfusion experiments reported above demonstrate improved control of electrolyte concentrations and perfusate volume, and removal of metabolic waste, during perfusion with rHD. An additional benefit was a decrease in the rate of haemolysis. To investigate the effect of transmembrane flux (TMF) on clearance of free haemoglobin, a blood-only perfusion experiment was conducted. The blood side of the circuit contained a reservoir, centrifugal pump, pressure sensor, and high cut-off dialysis filter. The blood inlet pressure was set at 80 mmHg. The dialysis side of the circuit included a reservoir, dialysis machine, and the filter. 45-minute treatments were applied with TMF set at zero, 45 ml/min, 70 ml/min, and back at zero. Flow measurements were taken on all limbs using an ultrasonic flow probe. The perfusate consisted of one unit of red cells plus 5% albumin to total volume of 600 ml (total Hb 123 g/L). 10 ml intentionally haemolysed red cells were then added. The dialysate used was 0.9% sodium chloride.

Table 2 shows the results of this experiment. Free haemoglobin can pass through the high cut-off filter by diffusion—this resulted in a fall from the starting perfusate concentration of 9.5 g/L to 7.0 g/L with 45 minutes of treatment (TMF=0). Surprisingly, the dialysate haemoglobin concentration fell with increasing TMF. This effect was reversible, with higher concentrations seen in the dialysate once TMF was returned to zero. Without wishing to be bound by theory, it is believed that this effect was caused by blockage of filter pores with red cells at high TMF. Secondly, administration of unfiltered dialysate as pre-dilution compromises the efficiency with which high molecular weight waste can be cleared.

TABLE 2
Increasing transmembrane flux has a paradoxical
effect on cleared free haemoglobin

| | Blood | | | |
|---|---|---|---|---|
| | supernatant | Dialysate | Blood | Dialysate |
| | Hb | Hb | albumin | albumin |
| Timepoint | (g/L) | (g/L) | (g/l) | (g/L) |
| Baseline | 9.5 | 0.0 | 47.3 | 0 |
| Post intervention 1 | 7.0 | 2.0 | 55.3 | 2.79 |
| (45 mins TMF | | | | |
| 0 ml/min) | | | | |
| Post intervention 2 | 12.0 | 1.8 | 56.2 | 0.55 |
| (45 mins TMF | | | | |
| 45 ml/min) | | | | |
| Post intervention 3 | 11 | 0.3 | 52.6 | 0.19 |
| (45 mins TMF | | | | |
| 70 ml/min) | | | | |
| Post intervention 4 | 10 | 1.2 | 58.7 | 0.44 |
| (45 mins TMF | | | | |
| 0 ml/min) | | | | |

Two adaptations were made to the design of the dialysis machine, as exemplified in FIG. 9 and discussed above: 1) a low cut-off filter (return filter 90) was included on the pre-dilution line (supplementary conduit 53); and 2) the pumps (61 and 62) were programmed to operate in a ‘push-pull’ mode (to provide an alternating transmembrane flux) to keep the filter pores clear by regular transient reversal of the pressure gradient across the membrane. Oscillations in rotational speed were programmed, with both the influx and efflux pumps (pumps 61 and 62 in FIG. 9) spending 300 ms at high speed and 700 ms at low speed, out of phase, and with net pump speed for the efflux pump higher than that of the influx pump. Long term average difference is calculated, with dynamic offset provided by the predilution pump (pump 63) to maintain overall volume neutrality. In one particular example implementation, the push-pull mode achieved transmembrane pressure swings of approximately 20 mmHg to −40 mmHg via the synchronous and opposite high/low influx/efflux pumps speeds. The push-pull mode of operation was observed to allow free haemoglobin to be efficiently removed from the perfusate and ‘trapped’ in the low cut-off filter (return filter 90) attached to the predilution line. Once concentrated in the predilution filter (return filter 90), small quantities of dialysate containing highly concentrated waste can be vented as required (e.g., via outlet 94).

Recirculated dialysis as applied by this system to ex-vivo normothermic organ perfusion systems (both liver and kidney) has been shown to stabilise electrolyte concentrations. Without rHD electrolyte concentrations vary widely, despite consistent application of a strict protocol, due in part to the inherent variability in the composition of units of red cells. The importance of this has been shown particularly with respect to calcium. Ionised perfusate calcium concentration depends on temperature and duration of incubation in the presence of red cells. In healthy, vasoactive organs with short cold ischaemia times, severe hypocalcemia is not possible to correct without inducing terminal vasospasm. rHD stabilises ionised calcium concentration within a tight range, preventing this occurring.

As well as electrolyte control, rHD permits precise control of circulating volume, and of metabolic waste products. Possibly due to improved osmotic control, there appears to be substantially less haemolysis when the liver perfusion circuit is dialysed. Finally, efficient clearance of high molecular weight DAMPs including cell-free haemoglobin is feasible using push-pull TMF and filtered pre-dilution. This system can be provided as an augmentation that can be applied to existing perfusion systems to facilitate long-duration organ preservation.

1. An apparatus for performing ex-vivo perfusion of an organ, comprising:
an organ receiving unit configured to receive an ex-vivo organ and provide fluidic connections to a vasculature of the received organ;
a first conduit system configured to define a perfusate flow circuit including a flow path through the vasculature of the received organ;
a perfusate pumping system configured to drive a circulatory flow of perfusate in the perfusate flow circuit and through the vasculature of the received organ;
a second conduit system defining a dialysate flow circuit;
a dialysate pumping system configured to drive a circulatory flow of a dialysate in the dialysate flow circuit; and
a dialysis unit configured to process the perfusate using the dialysate, the dialysis unit comprising a membrane configured to contact the perfusate in the perfusate flow circuit on one side of the membrane and the dialysate in the dialysate flow circuit on the other side of the membrane, the membrane being configured to allow material to pass between the perfusate flow circuit and the dialysate flow circuit as a transmembrane flux.

2. The apparatus of claim 1, further comprising a supplementary conduit and a supplementary dialysate pump, the supplementary dialysate pump being configured to pump dialysate via the supplementary conduit into the perfusate flow circuit upstream of the membrane of the dialysis unit.

3. The apparatus of claim 2, comprising a dialysate reservoir connected within the dialysate flow circuit and configured to contain dialysate.

4. The apparatus of claim 3, comprising a dialysate flow controller configured to control flow of dialysate in the apparatus.

5. The apparatus of claim 4, wherein the dialysate flow controller is configured to control the transmembrane flux by controlling the flow of dialysate in the apparatus.

6. The apparatus of claim 5, wherein the dialysate flow controller is configured to control the transmembrane flux at least partly by controlling a pressure of dialysate adjacent to the membrane in the dialysis unit.

7. The apparatus of claim 6, wherein:
the dialysate pumping system comprises an upstream dialysate pump provided upstream of the dialysis unit in the dialysate flow circuit;
the dialysate pumping system comprises a downstream dialysate pump provided downstream of the dialysis unit in the dialysate flow circuit; and
the dialysate flow controller is configured to control the pressure of dialysate adjacent to the membrane at least partly by controlling either or both of the upstream dialysate pump and the downstream dialysate pump.

8. The apparatus of claim 4, wherein the dialysate flow controller is configured to control the supplementary dialysate pump as a function of the transmembrane flux.

9. The apparatus of claim 8, wherein the dialysate flow controller is configured to perform a volume compensation process by controlling the supplementary dialysate pump to reduce or avoid changes to the volume of the perfusate in the perfusate flow circuit caused by the transmembrane flux.

10. The apparatus of claim 4, further comprising a perfusate sensor configured to measure a target parameter of perfusate in the perfusate flow circuit.

11. The apparatus of claim 10, wherein the dialysate flow controller is configured to control the transmembrane flux as a function of the measured target parameter.

12. The apparatus of claim 11, wherein the dialysate flow controller is configured to control the transmembrane flux to maintain the measured target parameter within a predetermined range of a target value.

13. The apparatus of claim 10, wherein the target parameter comprises haemocrit.

14. The apparatus of claim 13, wherein the dialysate flow controller is configured to:
respond to a case where the measured haemocrit is above a first predetermined threshold by decreasing a net transmembrane flux from the perfusate flow circuit to the dialysate flow circuit and/or increasing a rate of flow of dialysate into the perfusate flow circuit via the supplementary conduit; and/or
respond to a case where the measured haemocrit is below a second predetermined threshold by increasing a net transmembrane flux from the perfusate flow circuit to the dialysate flow circuit and/or decreasing a rate of flow of dialysate into the perfusate flow circuit via the supplementary conduit.

15. The apparatus of claim 4, wherein the dialysate flow controller and/or dialysate pumping system is configured to drive the flow of the dialysate in such a way as to provide an alternating transmembrane flux, the alternating transmembrane flux alternating between a net transmembrane flux from the perfusate flow circuit to the dialysate flow circuit and a net transmembrane flux from the dialysate flow circuit to the perfusate flow circuit.

16. The apparatus of claim 15, wherein the alternating transmembrane flux is biased to provide a non-zero transmembrane flux averaged over multiple cycles of the alternating transmembrane flux.

17. The apparatus of claim 2, further comprising a return filter configured to filter dialysate prior to the dialysate being pumped from the supplementary conduit into the perfusate flow circuit upstream of the membrane of the dialysis unit by the supplementary dialysate pump.

18. The apparatus of claim 17, wherein the return filter is configured to act as a finer filter than the membrane of the dialysis unit.

19. The apparatus of claim 2, wherein:
the apparatus comprises a perfusate port configured to allow perfusate to be added to or removed from the perfusate flow circuit; and
the apparatus is configured to perform a flushing process by progressively diluting the perfusate by providing a net flow of dialysate into the perfusate flow circuit via the supplementary conduit and a net flow of perfusate out of the perfusate flow circuit via the perfusate port.

20. The apparatus of claim 19, comprising a temperature controller configured to cool the perfusate during the flushing process.

21. The apparatus of claim 2, wherein:
the apparatus comprises a perfusate port configured to allow perfusate to be added to or removed from the perfusate flow circuit; and
the apparatus is configured to perform a perfusate introduction process including progressively increasing a concentration of cellular matter in the perfusate in the perfusate flow circuit by inputting cellular matter to the perfusate flow circuit via the perfusate port and removing non-cellular matter from the perfusate flow circuit as transmembrane flux into the dialysate flow circuit.

22. The apparatus of claim 21, comprising a temperature controller configured to warm the perfusate during the perfusate introduction process.

23. The apparatus of claim 1, comprising a perfusate reservoir connected within the perfusate flow circuit and configured to contain perfusate.

24. The apparatus of claim 1, wherein the perfusate flow circuit and the dialysate flow circuit are configured to substantially prevent flow of cellular components of the perfusate from the perfusate flow circuit to the dialysate flow circuit.

25. The apparatus of claim 1, wherein the membrane is configured to promote clearance of uremic toxins in the range of 5-50 kDa.

26. The apparatus of claim 1, wherein:
the perfusate flow circuit comprises a primary flow section and a secondary flow section, the primary flow section being in parallel with the secondary flow section;
the primary flow section has a lower flow resistance than the secondary flow section; and
the dialysis unit is connected within the secondary flow section.

27. The apparatus of claim 1, wherein the dialysis unit is connected within a flow section of the perfusate flow circuit that is configured to accommodate all or a majority of flow within the perfusate flow circuit.

28. The apparatus of claim 27, wherein the dialysis unit is connected to the first conduit system and the second conduit system in such a way that a flow resistance presented to the first conduit system by the dialysis unit is lower than a flow resistance presented to the second conduit system by the dialysis unit.

29. A method of performing ex-vivo perfusion of an organ, comprising:
connecting an organ in an ex-vivo state to an organ receiving unit;
driving a circulatory flow of a perfusate in a perfusate flow circuit and through the organ;
driving a circulatory flow of a dialysate in a dialysate flow circuit; and
using a dialysis unit to process the perfusate using the dialysate, wherein the dialysis unit comprising a membrane that contacts the perfusate in the perfusate flow circuit on one side of the membrane and the dialysate in the dialysate flow circuit on the other side of the membrane, the membrane allowing material to pass between the perfusate flow circuit and the dialysate flow circuit as a transmembrane flux.
